(19) United States
(12) Patent Application Publication
(10) Pub. No.: US 2026/0228184 A1
(43) Pub. Date: Aug. 6, 2026

(54) DATA MAPPING

(71) Applicant: Insight Direct USA, Inc., Chandler, AZ (US)

(72) Inventor: Michael Griffin, Wayland, MA (US)

(21) Appl. No.: 19/464,040

(22) Filed: Jan. 29, 2026

Related U.S. Application Data
(60) Provisional application No. 63/752,180, filed on Jan. 31, 2025.

(51) Int. Cl. G06F 16/20

(52) U.S. Cl. CPC G06F 16/20

(57) ABSTRACT

A method of converting database data includes extracting a first plurality of field types from a first plurality of records, extracting a second plurality of field types of a second plurality of records, comparing each field type of the first plurality of field types with each field type of the second plurality of field types, linking corresponding data fields of the first plurality of data fields to and the second plurality of data fields, performing pairwise comparisons of field types of remainders of the first plurality of data fields and the second plurality of data fields using a machine-learning language model, and linking corresponding data field of the at least a portion of the remainder of the first plurality of data fields and the at least a portion of the remainder of the second plurality of data fields.

### CROSS-REFERENCE TO RELATED APPLICATION

This application claims the benefit of U.S. Provisional Patent Application No. 63/752,180, filed January 31, 2025, and entitled “DATA MAPPING,” the disclosure of which is hereby incorporated by reference in its entirety.

### FIELD OF THE INVENTION

The present disclosure relates to tabular data, more particularly, systems and methods for automated data mapping for tabular data.

### BACKGROUND

Machine learning has a wide range of applications and various machine-learning models can be trained to make predictions useful for the performance of various tasks, such as classification, value prediction, content generation, etc. Some machine learning strategies use labeled data to train a machine-learning model to make predictions. Various preprocessing can be performed to data prior to training to enhance the quality of the data for training, thereby increasing the accuracy of the trained model, reducing the likelihood of overfitting, and otherwise improving model performance.

### SUMMARY

An example of a method of converting database data includes receiving a first data table comprising a first plurality of records organized into a first plurality of data fields, receiving a second data table comprising a second plurality of records organized into a second plurality of data fields, extracting a first plurality of field types from the first plurality of data fields, and extracting a second plurality of field types from the second plurality of data fields. Each field type of the first plurality of field types describes a different one data field of the first plurality of data fields and each field type of the second plurality of field types describes a different one data field of the second plurality of data fields. The example of the method further includes comparing each field type of the first plurality of field types with each field type of the second plurality of field types to identify a portion of the first plurality of data fields and a portion of the second plurality of data fields having equivalent field types, and linking each data field of the portion of the first plurality of data fields to a corresponding data field of the portion of the second plurality of data fields, such that corresponding data fields of the portions of the first and second pluralities of data fields have an equivalent field type. The example of the method yet further includes performing pairwise comparisons of field types of each of a remainder of the first plurality of data fields and a remainder of the second plurality of data fields using a machine-learning language model to identify at least a portion of the remainder of the first plurality of data fields and at least a portion of the remainder of the second plurality of data fields having equivalent field types, and linking each data field of the at least a portion of the remainder of the first plurality of data fields to a corresponding data field of the at least a portion of the remainder of the second plurality of data fields, such that corresponding data fields of the remainders of the first and second pluralities of data fields have an equivalent field type.

An example of a system for converting database data includes a processor and at least one memory encoded with instructions. The instruction, when executed, cause the processor to receive a first data table comprising a first plurality of records organized into a first plurality of data fields, receive a second data table comprising a second plurality of records organized into a second plurality of data fields, extract a first plurality of field types from the first plurality of data fields, and extract a second plurality of field types from the second plurality of data fields. Each field type of the first plurality of field types describes a different one data field of the first plurality of data fields and each field type of the second plurality of field types describes a different one data field of the second plurality of data fields. The instructions, when executed, further cause the processor to compare each field type of the first plurality of field types with each field type of the second plurality of field types to identify a portion of the first plurality of data fields and a portion of the second plurality of data fields having equivalent field types, and to link each data field of the portion of the first plurality of data fields to a corresponding data field of the portion of the second plurality of data fields, such that corresponding data fields of the portions of the first and second pluralities of data fields have an equivalent field type. The instructions, when executed, yet further cause the processor to perform pairwise comparisons of field types of each of a remainder of the first plurality of data fields and a remainder of the second plurality of data fields using a machine-learning language model to identify at least a portion of the remainder of the first plurality of data fields and at least a portion of the remainder of the second plurality of data fields having equivalent field types, and link each data field of the at least a portion of the remainder of the first plurality of data fields to a corresponding data field of the at least a portion of the remainder of the second plurality of data fields, such that corresponding data fields of the remainders of the first and second pluralities of data fields have an equivalent field type.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic diagram of an example of a system for automated data field mapping.

FIG. 2 is a schematic diagram of a further example of a system for automated data field mapping.

FIG. 3 is a flow diagram of an example of a method of data field mapping by the systems of FIG. 1 and FIG. 2.

FIG. 4 is a flow diagram of an example of a method of data field type comparison using a machine-learning language model that is performable by the systems of FIG. 1 and FIG. 2.

FIG. 5 is a flow diagram of an example of a method of training a machine-learning model using tabular data merged by the method FIG. 3.

While the above-identified figures set forth one or more examples of the present disclosure, other examples are also contemplated, as noted in the discussion. In all cases, this disclosure presents the invention by way of representation and not limitation. It should be understood that numerous other modifications and examples can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The present disclosure relates to systems and methods for automated mapping data table mapping. In particular, the present disclosure relates to systems and methods that enable the automated mapping of data fields that describe the same, substantially the same, or otherwise equivalent types of data but that have non-identical data field types. The data table mapping and merging described herein enable significant improvements in processing of raw, tabular data from different sources or that otherwise have non-identical data field information into labeled training data suitable for use for training a conventional machine-learning model, such as an artificial neural network. Notably, existing methods for mapping and merging tabular data require human intervention and, accordingly, are both labor- and time-intensive. Advantageously, the present disclosure provides methods that can be performed automatedly by a computer system, significantly reducing the time and labor required to merge multiple data tables before using the data tables to train a machine-learning model.

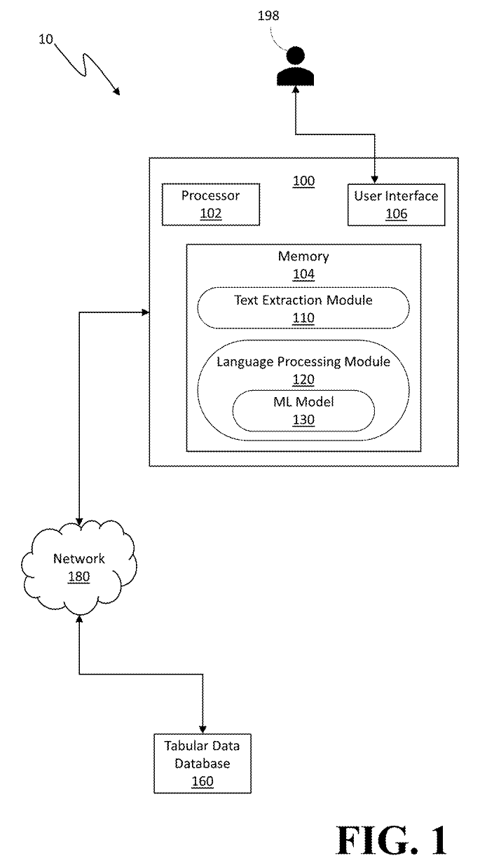

FIG. 1 is a schematic depiction of system 10, which is a system for automatedly mapping data table fields based on field type text data. System 10 includes server 100, tabular data database 160, and network 180. Server 100 includes processor 102, memory 104, and user interface 106. Memory 104 stores text extraction module 110 and language processing module 120. Language processing module 120 includes machine learning (ML) model 130. FIG. 1 also depicts user 198.

Server 100 is configured to automatedly map tables having fields with non-identical field type labeling information. More specifically, the program(s) of server 100 enable server 100 to match data fields storing equivalent or similar information but having non-identical field types. As referred to herein, a “field type” is text data that describes the meaning of the data stored by the data field. For example, a field type may be “visit date,” “medication prescribed,” a timestamp of a time-series data set, etc. A field type usable by the program(s) of server 100 can be any suitable text string that describes the meaning of the data stored in that field. Advantageously, this allows for data tables from different sources, institutions, authors, etc. to be related. Once related, the data stored by the data tables can be used in aggregate to train a machine-learning model, such as an artificial neural network. Further, as referred to herein, “mapping” or “data mapping” refers to the processing of matching data fields from one database or data table to another database or data table.

Processor 102 can execute software, applications, and/or programs stored on memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry. Processor 102 can be entirely or partially mounted on one or more circuit boards.

Memory 104 is configured to store information and, in some examples, can be described as a computer-readable storage medium. Memory 104, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that that the memory does not maintain stored contents when power to the memory 104 is turned off. Examples of volatile memories can include random access memories (RAM), dynamic random access memories (DRAM), static random access memories (SRAM), and other forms of volatile memories. In some examples, the memory is used to store program instructions for execution by the processor. Memory 104, in one example, is used by software or applications running on server 100 (e.g., by a computer-implemented machine-learning model) to temporarily store information during program execution.

Memory 104 can further be configured for long-term storage of information. In some examples, memory 104 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 106 is an input and/or output device and/or software interface, and enables an operator to control operation of and/or interact with software elements of server 100. For example, user interface 106 can be configured to receive inputs from an operator and/or provide outputs. User interface 106 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

Tabular data database 160 is an electronic database that is connected to server 100 via network 180. Tabular data database 160 stores tabular data suitable for processing via the program(s) of server 100. Tabular data database 160 can store tabular data in any suitable format and can include tabular data from any suitable number of authors, data sources, institutions, etc. Tabular data database 160 can be, for example, a structured database (e.g., a table or relational database), a semi-structured database (e.g., a hierarchical and/or nested database), and/or an unstructured database, but is generally configured to be queried by server 100 to retrieve two or more tabular data sets for mapping via the program(s) of text extraction module 110 and language processing module 120.

Tabular data database 160 and/or raw data source 170 can optionally organize data using database management systems. As used herein, a “database management system” refers to a system of organizing data stored on a data storage medium. In some examples, a database management system described herein is configured to run operations on data stored on the data storage medium. The operations can be requested by a user and/or by another application, program, and/or software. A database management system can be implemented as one or more computer programs stored on at least one memory device and executed by at least one processor to organize and/or perform operations on stored data.

Network 180 is a network suitable for connecting and facilitating network communication between two or more of server 100, error-function database 150, and raw data source 170. Network 180 can include any suitable combination of local area network (LAN) and wide area network (WAN) elements or components to facilitate communication between two or more of server 100, error-function database 150, and raw data source 170. In some examples, network 180 can be or include the Internet.

Text-extraction module 110 is a software module of server 100 and includes one or more software programs for extracting field type data as text from tabular data retrieved from tabular data database 160. Text-extraction module 110 can store extracted text data to memory 104 for analysis by the program(s) of language processing module 120.

Language processing module 120 is another software module of server 100 and includes one or more programs for processing text extracted by text-extraction module 110 to identify tabular data fields that represent the same or substantially the same type of information and, accordingly, can be linked. Language processing module 120 includes machine-learning (ML) model 130. Language processing module 120 can include one or more programs for determining whether text data is identical and, further, can compare non-identical text data using ML model 130. ML model 130 is a machine-learning language model capable of processing natural-language and providing an output recognizable by language processing module 120. ML model 130 can be, for example, a natural-language processing module 130 capable of assessing semantic similarity between two text phrases. ML model 130 can also be, for example, a generative language model capable of outputting a natural-language text string predictive of whether two or more text phrases are similar.

In examples where ML model 130 is a generative language model, language processing module 120 can include one or more programs for generating a prompt for comparing two or more text strings extracted from two or more data tables and determining whether those text strings are semantically similar and/or are likely to describe the same type of data. Where ML model 130 is a generative language model, ML model 130 can be trained to generate natural-language outputs (or tokenized representations thereof) from natural-language inputs (or tokenized representations thereof). In some of these examples, language model 130 and/or language processing module 120 can include one or more programs for converting natural-language inputs into numeric representations and for converting numeric representations of text information into natural-language text. ML model 130 can be, for example, a transformer model, such as a Large Language Model Meta AI (LLaMA) model or a Generative Pre-trained Transformer (GPT) model.

While one ML model 130 is depicted in FIG. 1 for explanatory clarity and convenience, in some examples, language processing module 120 can include multiple ML models 130. For example, language processing module 120 can include both a natural-language processing module, such as a semantic similarity model, and a generative language model. The natural-language processing model can be used to make initial comparisons of all field types between two or more data tables and field types not linked during that initial comparison can be further compared by the generative language model. Advantageously, this method can improve the number of initial matches made and thereby reduce the volume of queries made to the generative language model, consequently reducing the total computational cost of field matching performed by server 100.

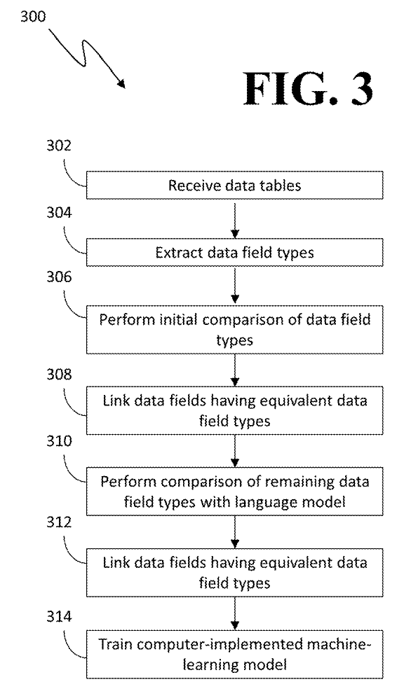

ML model 130 can also be used to generate data field type information for data tables lacking data field types for one or more fields. Text extraction module 110 can extract the text from each cell within the field and language processing module 120 can generate a prompt for ML model 130 including the extracted text and an instruction to predict the data field type based on the extracted text from cells of the field. Language processing module 120 can then assign that data field type to the field and use the machine-generated data field type for data field merging via, e.g., method 300 (FIG. 3), discussed subsequently herein.

The modules of server 100 are shown as separate software components in FIG. 1 for explanatory clarity and convenience. In other examples, text extraction module 110 and language processing module 120 can be part of a single software program and/or application. Further, each of server 100 and tabular data database 160 are depicted in FIG. 1 as single devices for explanatory convenience. In other examples, server 100 and tabular data database 160 can be distributed across any suitable number of devices. Similarly, each of server 100 and tabular data database 160 are depicted as single devices in FIG. 1 for explanatory convenience. In other examples, server 100 and tabular data database 160 can be integrated into a single physical device and/or a single virtual device distributed across any suitable number of physical devices.

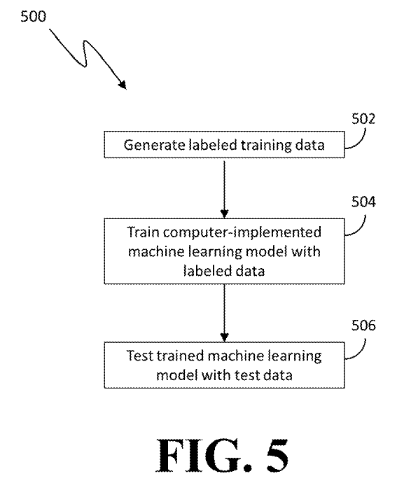

As will be explained subsequently and particularly with respect to the discussion of FIG. 3, system 10 enables the automated merging of tabular data fields having non-identical field type information that nonetheless describe or relate to the same type of data or information. Tabular data merged by system 10 can be used to train a computer-implemented machine-learning model via, e.g., method 500 (FIG. 5), discussed in more detail subsequently.

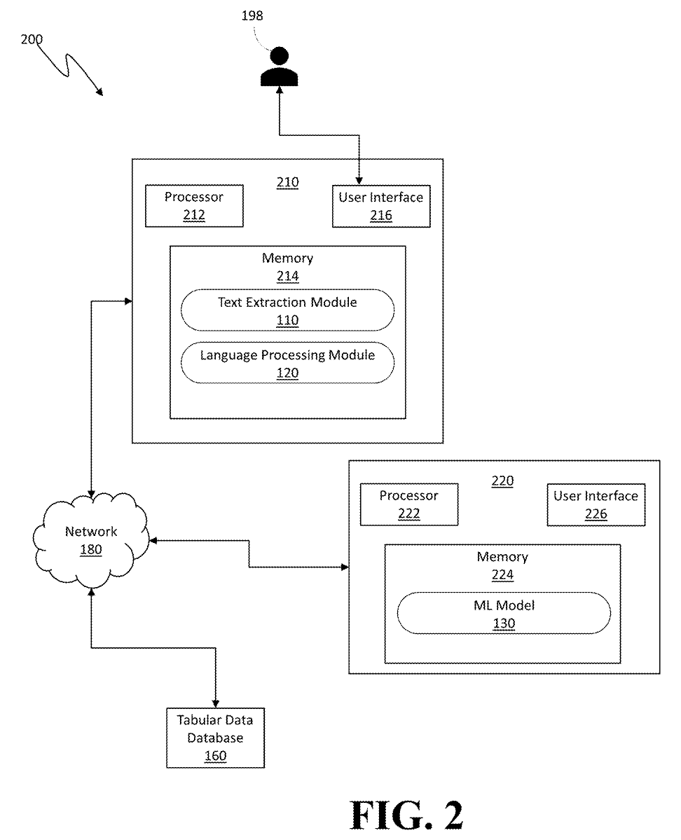

FIG. 2 is a schematic diagram of system 200, which is another system for automatedly mapping data table fields based on field type text data. System 200 includes server 210, server 220, error-function database 160, and network 180. Server 210 includes processor 212, memory 214, and user interface 216. Server 220 includes processor 222, memory 224, and user interface 226. Memory 214 stores text extraction module 110 and language processing module 120 as described above with reference to FIG. 1. Memory 224 stores ML model 130. FIG. 2 also depicts user 198.

Processor 212 and processor 222 are substantially similar to processor 102 of system 10 (FIG. 1), and the discussion of processor 102 is applicable to processor 212 and processor 222. Memory 214 and memory 224 are substantially similar to memory 104 of system 10 (FIG. 1), and the discussion of memory 104 is applicable to memory 214 and processor 224.

System 200 is substantially similar to system 10, but includes separate servers 210 and 220 instead of a single server 100. Server 210 includes text extraction module 110 and language processing module 120, and server 220 includes ML model 130. Accordingly, in system 200, server 210 performs text extraction tasks using text extraction module 110, can perform some initial data field type comparisons using language processing module 120, and generates prompts for ML model 130 using language processing module 120. Server 210 and server 220 are connected via network 180. Server 220 receives prompts from server 210 via network 180 and enables server 210 to access the functionality of ML model 130. Server 220 can operate an application programming interface (API) or another suitable interface to enable server 210 to access ML model 130. Additionally and/or alternatively, server 220 can include one or more programs that receive prompts from server 210, provide those prompts as inputs to ML model 130, and transmit outputs from ML model 130 to server 210.

FIG. 3 is a flow diagram of method 300, which is a method of data field merging according to the present disclosure. Method 300 includes steps 302–314 of receiving data tables (step 302), extracting data field types (step 304), performing initial comparison of data field types (step 306), linking data fields having equivalent data field types (step 308), performing a comparison of the remaining data field types using a language model (step 310), linking data fields having equivalent data field types (step 312), and training a computer-implemented machine-learning model (step 314). Method 300 is performable by system 10 (FIG. 1) and is generally discussed generally herein with reference to system 10. However, in other examples, method 300 can be performed by any suitable computing system.

While method 300 can be performed by comparing any suitable number of data tables, for explanatory convenience, method 300 is discussed herein with respect to the comparison and merging of data between two data tables. In further examples, method 300 can also be performed iteratively to compare a group of three or more data tables by first merging two data tables to create a merged data set, subsequently comparing the merged data set to a new data table to create a new merged data set, and iterating through all data tables in that manner.

In step 302, server 100 receives two data tables. Server 100 can query or otherwise receive the two tables from tabular data database 160. In some examples, server 100 receives the two tables form tabular data database 160 based on input from user 198 at user interface 106.

In step 304, text-extraction module 110 extracts data field types from the data tables received in step 302. The program(s) of text-extraction module 110 can automatically detect field type information and extract any available field type information for each field of the tables received in step 302.

As described previously, language processing module 120 can automatedly and/or automatically generate data field type information for any data fields of either table that do not have data field type information. For each data field not having data field type information, text extraction module 110 can extract text from each cell within the field and language processing module 120 can generate a prompt for ML model 130 instructing ML model 130 to predict a data field type based on the extracted text from cells of the field. Language processing module 120 can then assign that data field type to the field and use the machine-generated data field type for data field can be used with subsequent steps of method 300.

In step 306, language processing module 120 performs an initial comparison of data field types extracted in step 304. Language processing module 120 compares each field type for one table to each other field type of the other table, thereby performing a pairwise comparison of all possible cross-table field type combinations. Language processing module 120 can use a language comparison model to perform step 306.

The language comparison model can, for example, be configured to determine whether two text phrases are identical. In these examples, language comparison module 120 performs step 306 by determining whether the text information for a field type of one table is identical to any of the field types of the other table.

In other examples, the language comparison model can be a natural-language processing model configured to assess semantic similarity. In these examples, the comparison performed in step 310 can be performed using a different type of machine-learning model, such as a transformer and/or generative language model. Additionally and/or alternatively, the comparison performed in step 310 can be performed using a natural-language processing model having a greater number of trainable parameters than the model used for step 306, such that the comparisons performed in step 306 are less-computationally expensive than the comparisons performed in step 310.

In step 308, language processing module 120 links data fields found in step 306 to have equivalent field types. Based on the initial comparison performed in step 306, language processing module 120 identifies field type pairs that are equivalent (i.e., that have the same, substantially the same, semantically-related, etc. text information). Language processing module 120 can link equivalent data fields in any suitable manner and, in at least some examples, can merge equivalent fields into a single field.

In step 310, the remaining data field types are compared using a language model. Step 310 compares data field types belonging to data fields that were not linked in step 308 (i.e., field types not found to be equivalent in step 308). The language model performs a more computationally-expensive comparison that has better detection of semantic equivalence than the comparison performed in step 306. The comparison in step 310 generally is able to detect semantic similarity between data field types having less similar text data than the comparison performed in step 306. Language processing module 120 uses ML model 130 to perform the comparison in step 310. In at least some examples, ML model 130 can be a generative and/or transformer model suitable for performing step 310. In other examples, ML model 130 can be a natural-language processing model.

In step 312, language processing module 120 links data fields found in step 310 to have equivalent field types. Language processing module 120 can link equivalent data fields in any suitable manner and, in at least some examples, can merge equivalent fields into a single field. The processing of linking data fields via steps 308 and 312 can be referred to as “merging” or “mapping,” among other terms known in the art.

After step 312 and before step 314, language processing module 120 and/or another suitable program of server 100 can merge the records for the two data tables into a single data table. Linked fields can become a single field and any remaining unlinked fields can also be present in the table. Records having no value for an unlinked field (i.e., a field belonging to the other data table than the table from which the records originated) can be automatedly given a null value or another suitable value indicating that no data exists for those records for the unlinked field. In other examples, linking data fields in step 308 and step 312 is sufficient to merge the data tables for downstream use (e.g., in step 314).

In step 314, the merged data can be used to train a computer-implemented machine-learning model. The computer-implemented machine-learning model can be any suitable computer-implemented machine-learning model and, in at least some examples, is an artificial neural network. Step 314 can be performed according to method 500, discussed subsequently.

Method 300 advantageously enables the automated merging of data tables having differing fields. Often, different sources of data will use different text strings to describe the same data fields (i.e., different field types that have the same semantic meaning). Advantageously, method 300 enables data from different data sources having different field types to be merged in an automated manner, reducing both time and labor required for data merging.

As compared to raw and unmapped data, data field mapping via method 300 improves training of machine-learning models by enabling data fields having the same or substantially the same meaning to be used together for machine-learning training. That is, the identification of facially-different fields as, in fact, different representations the same field, as can be performed automatedly via method 300, increases the total data available with which to train a machine-learning model for that field. Further, failing to recognize that facially-different fields are, in fact, different representations of the same field can bias or otherwise reduce the accuracy of a machine-learning model trained on unmerged or unmapped data. Method 300 accordingly improves training data by reducing the likelihood of negative training outcomes and increasing the likelihood of positive training outcomes when using training data assembled from multiple sources. Further, method 300 does so without requiring labor-intensive manual comparison of each data field in two or more data tables.

Notably, healthcare data, such as patient health data, from different hospitals or hospital systems often has differing field type information to describe the same or substantially the same data. Advantageously, method 300 is able to automate the merging of healthcare data (e.g., patient health data) to enable that healthcare data to more effectively train machine-learning models.

Synthetic data often also has unusual, inconsistent, and/or non-standard field type information. Synthetic data can be useful for training machine-learning models to demonstrate the ability of a machine-learning approach to solve a particular problem and/or to otherwise function as a proof-of-concept of a particular machine-learning approach without requiring time-consuming harvesting and processing of real data. Furthermore, synthetic data can be particularly useful where real data is difficult to acquire real data otherwise required to validate and/or demonstrate applications of a machine-learning approach.

As a specific example, patient health data can be difficult to acquire and often is legally-protected from disclosure to unauthorized parties. However, a third-party contractor may desire to propose a machine-learning approach to solve a gap in diagnosis, treatment, etc. to an entity legally- or otherwise-authorized to collect patient data. In these examples, synthetic patient data can be used instead of real patient data to train a machine-learning model for demonstration purposes as part of, for example, a project proposal.

In these examples, a generative machine-learning language model can be used to generate coherent patient data without requiring subject-matter expertise and, further, without requiring manual data creation for a dataset suitably large to train another machine-learning model to make predictions based on the patient health information. As a particular example, sequential, iterative prompting of a machine-learning model can be used to generate individual patient profiles, where each output is used by the machine-learning language model in combination with the following prompt. The written patient profile can then be transformed into tabular data. The machine-learning language model can be prompted to first create biographical information for a fictitious patient and then create basic patient health information for that fictitious patient, such as a quantity of encounters with the healthcare system and/or a description of whether those encounters were in-patient or out-patient visits. The machine-learning language model can then be prompted to generate data describing whether the fictitious patient’s vitals were measured during each visit and, if they were, to create values for those measurements. Based on those outputs, the machine-learning language model can then be prompted to generate a data describing whether any laboratory tests were performed during those fictitious visits and, if they were, to create data for those laboratory tests. The machine-learning language model can then be further prompted to create diagnoses based on the previously-generated data and to create medication or other treatment plans for those diagnoses. The resultant text data can be transformed into tabular data using any suitable software program. In at least some examples, a machine-learning model, such as a natural-language model and/or a generative language model can be used to extract text information and/or transform that extracted text information into tabular data. The generative language model can also be used to generate field types for each data field of the tabular data, as described previously with respect to step 304 of method 300.

The aforementioned sequential prompting method is merely one exemplary method of synthetic data generation using a generative machine-learning language model and, in other examples, a different method can be used to generate synthetic data.

The aforementioned process of automatedly generating synthetic data by sequentially prompting a machine-learning language model and, subsequently, of automatedly or semi-automatedly converting that text data into a tabular format often results in tabular data that has inconsistent and/or non-standard field type data, which can increase the difficulty required to merge synthetic tabular data with other synthetic tabular data and/or with real data. Method 300, advantageously, automates and reduces the time required to merge synthetic tabular data with real tabular data and/or with other synthetic data.

Method 300 can be performed any suitable number of times to map any suitable number of data tables. In at least some examples, method 300 can be performed across all tables of multiple databases to map the data tables of those databases prior to use the merged database information to train a machine-learning model.

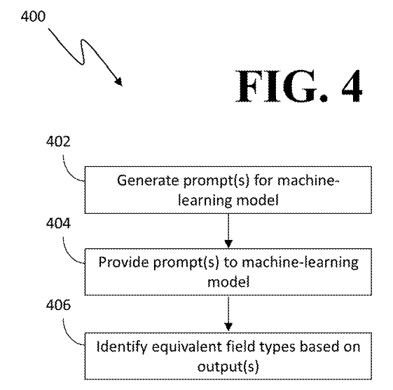

FIG. 4 is a flow diagram of method 400, which is a method of comparing two or more field types for two or more data fields. Method 400 can be used to perform step 310 of method 300 (FIG. 3), and includes steps 402–406 of generating one or more prompts for a machine-learning language model (step 402), providing the one or more prompts to the machine-learning language model (step 404), and identifying equivalent field types based on the output(s) of the machine-learning language model (step 406). Method 400 is performable by system 10 (FIG. 1) and is generally discussed generally herein with reference to system 10. However, in other examples, method 400 can be performed by any suitable computing system.

In step 402, language processing module 120 generates one or more prompts to the machine-learning language model to be used for performing the comparison. The machine-learning language model can be, for example, ML model 130. Each prompt can include two or more field types extracted by text extraction module 110, and can also include instructions for the machine-learning language model (i.e., to perform pairwise comparisons of all field types in the prompt). The prompts can be generated in any suitable manner and, in some examples, can be generated using a template that provides instructions to the machine-learning language model to perform the comparison.

In step 404, language processing module 120 provides the prompts to the machine-learning language model. Providing the prompts in step 404 causes the machine-learning language model to generate an output including a prediction or determination as to whether any pairs of field types in the prompt are equivalent. Step 402 can produce any number of prompts that can be submitted to the machine-learning language model and each prompt can include a request to compare any two or more field types. However, collectively, all prompts created in step 402 enable the pairwise comparison of all possible combinations of unique field types. In at least some examples, there is a separate prompt for each comparison. Further, in at least some further examples, there is a single prompt that includes all unique field types and that instructs the machine-learning language model to make pairwise comparisons of all possible combinations of those field types.

In step 406, language processing module 120 identifies equivalent field types based on the output(s) produced step 404. Text extraction module 110 or another program of server 100 (e.g., a program of language processing module 120) can extract and/or analyze text in the output(s) generated in step 406 to identify pairs of field types that were identified as equivalent in the output(s).

FIG. 5 is a flow diagram of method 500, which is a method of training a machine-learning algorithm according to the present disclosure. Method 500 can be used to train machine-learning model based on data processed via method 300 (FIG. 3) and is one example of a method that can be used to perform step 314 of method 300. Method 500 includes steps of generating training data and test data (step 502), training a computer-implemented machine-learning model with the training data (step 504), and testing the trained computer-implemented machine-learning model with the test data (step 506). Method 500 can be used to train any suitable machine-learning model and can be used, for example, to train a neural network to score image focus.

In step 502, processor 102 generates labeled training data and labeled test data based on tabular data merged via method 300 (FIG. 3). Labeled data can be extracted from the tabular data to train the machine learning model to make a prediction based on one or more input values. In at least some examples, a portion (e.g., a majority) of the labeled data can be designated as training data and a remainder (e.g., a minority) of the labeled data can be designated as test data. In other examples, the error-corrected tabular data can be used as training data and additional data of the same kind can be used as test data.

In step 504, the training data is used to train the computer-implemented machine-learning model. As used herein, “training” a computer-implemented machine-learning model refers to any process by which parameters, hyperparameters, weights, and/or any other value related model accuracy are adjusted to improve the fit of the computer-implemented machine-learning model to the training data. Training in step 504 can be performed iteratively to iteratively adjust and improve the fit of the model to the training data.

In step 506, the trained computer-implemented machine-learning model is tested with test data. More specifically, a human operator or computer program can evaluate the performance of the machine-learning model by evaluating the fit of the model to the test data. The fit of the model can be evaluated to all or a portion of the test data generated or received in step 502.

In some examples, method 500 can be performed iteratively to improve the performance of the machine-learning model. More specifically, if the fit of the model to the test data determined in an iteration of step 506 is undesirable, step 504 can be repeated to further adjust the parameters, hyperparameters, weights, etc. of the model (e.g., via re-training) to improve the model. Step 506 can then be repeated with a new set of test data (e.g., a different subset of the test data generated in step 502) and/or the same set of test data to determine how the adjusted model fits the test data. If the fit continues to be undesirable, further iterations of steps 504 and 506 can be performed until the fit of the model becomes desirable.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of converting database data, the method comprising:
receiving a first data table comprising a first plurality of records organized into a first plurality of data fields;
receiving a second data table comprising a second plurality of records organized into a second plurality of data fields;
extracting a first plurality of field types from the first plurality of data fields, wherein each field type of the first plurality of field types describes a different one data field of the first plurality of data fields;
extracting a second plurality of field types from the second plurality of data fields, wherein each field type of the second plurality of field types describes a different one data field of the second plurality of data fields;
comparing each field type of the first plurality of field types with each field type of the second plurality of field types to identify a portion of the first plurality of data fields and a portion of the second plurality of data fields having equivalent field types;
linking each data field of the portion of the first plurality of data fields to a corresponding data field of the portion of the second plurality of data fields, such that corresponding data fields of the portions of the first and second pluralities of data fields have an equivalent field type;
performing pairwise comparisons of field types of each of a remainder of the first plurality of data fields and a remainder of the second plurality of data fields using a machine-learning language model to identify at least a portion of the remainder of the first plurality of data fields and at least a portion of the remainder of the second plurality of data fields having equivalent field types; and
linking each data field of the at least a portion of the remainder of the first plurality of data fields to a corresponding data field of the at least a portion of the remainder of the second plurality of data fields, such that corresponding data fields of the remainders of the first and second pluralities of data fields have an equivalent field type.

2. The method of claim 1, wherein performing pairwise comparisons of field types of each of the remainder of the first plurality of data fields and each of the remainder of the second plurality of data fields using the machine-learning language model comprises:
generating a plurality of prompts for a machine-learning model, each prompt instructing the machine-learning model to compare a field type of one data filed of the remainder of the first plurality of data fields to a field type of one data field of the remainder of the second plurality of data fields;
providing the plurality of prompts to the machine-learning language model to generate a plurality of relatedness determinations; and
based on the plurality of relatedness determinations, identifying the at least a portion of the remainder of the first plurality of data fields and the at least a portion of the remainder of the second plurality of data fields having equivalent field types.

3. The method of claim 2, wherein the first plurality of records is a first plurality of patient health records and the second plurality of records is a second plurality of patient health records.

4. The method of claim 3, wherein all patient health records of the second plurality of patient health records are synthetic patient health records.

5. The method of claim 4, wherein the first plurality of patient health records does not include synthetic patient health records.

6. The method of claim 5, and further comprising, after linking each data field of the at least a portion of the remainder of the first plurality of data fields to the corresponding data field of the at least a portion of the remainder of the second plurality of data fields, training a computer-implemented machine-learning model using data of at least one data field of the first plurality of data fields and at least one linked data field of the second plurality of data fields.

7. The method of claim 6, wherein the computer-implemented machine-learning model is a neural network model.

8. The method of claim 5, and further comprising generating each patient health record of the second plurality of patient health records by sequentially prompting a transformer-based language model with each prompt of a set of synthetic health record generation prompts.

9. The method of claim 8, and further comprising generating the second data table by extracting text data from the second plurality of patient health records.

10. The method of claim 5, wherein the machine-learning language model is a transformer model.

11. The method of claim 10, wherein comparing each field type of the first plurality of field types with each field type of the second plurality of field types comprises comparing each field type of the first plurality of field types with each field type of the second plurality of field types using a language comparison model.

12. The method of claim 11, wherein the language comparison model is a natural-language processing model.

13. The method of claim 12, wherein the natural language processing model is a semantic matching model.

14. The method of claim 13, and further comprising generating a field type of the second plurality of field types for a data field of the second plurality of data fields storing text strings by:
extracting all text data for each entry in the data field, thereby extracting a plurality of text data;
generating a prompt for the machine-learning language model, wherein the prompt includes the plurality of text data and an instruction to generate one or more natural-language words descriptive of the plurality of text data;
providing the prompt to the machine-learning language model to generate the one or more natural-language words; and
modifying the second data table to store the one or more natural-language words as the field type.

15. A system for converting database data, the system comprising:
a processor; and
at least one memory encoded with instructions that, when executed, cause the processor to:
receive a first data table comprising a first plurality of records organized into a first plurality of data fields;
receive a second data table comprising a second plurality of records organized into a second plurality of data fields;
extract a first plurality of field types from the first plurality of data fields, wherein each field type of the first plurality of field types describes a different one data field of the first plurality of data fields;
extract a second plurality of field types from the second plurality of data fields, wherein each field type of the second plurality of field types describes a different one data field of the second plurality of data fields;
compare each field type of the first plurality of field types with each field type of the second plurality of field types to identify a portion of the first plurality of data fields and a portion of the second plurality of data fields having equivalent field types;
link each data field of the portion of the first plurality of data fields to a corresponding data field of the portion of the second plurality of data fields, such that corresponding data fields of the portions of the first and second pluralities of data fields have an equivalent field type;
perform pairwise comparisons of field types of each of a remainder of the first plurality of data fields and a remainder of the second plurality of data fields using a machine-learning language model to identify at least a portion of the remainder of the first plurality of data fields and at least a portion of the remainder of the second plurality of data fields having equivalent field types; and
link each data field of the at least a portion of the remainder of the first plurality of data fields to a corresponding data field of the at least a portion of the remainder of the second plurality of data fields, such that corresponding data fields of the remainders of the first and second pluralities of data fields have an equivalent field type.

16. The system of claim 15, wherein the instructions, when executed, cause the processor to perform the pairwise comparisons of field types of each of the remainder of the first plurality of data fields and each of the remainder of the second plurality of data fields using the machine-learning language model by:
generating a plurality of prompts for a machine-learning model, each prompt instructing the machine-learning model to compare a field type of one data filed of the remainder of the first plurality of data fields to a field type of one data field of the remainder of the second plurality of data fields;
providing the plurality of prompts to the machine-learning language model to generate a plurality of relatedness determinations; and
based on the plurality of relatedness determinations, identifying the at least a portion of the remainder of the first plurality of data fields and the at least a portion of the remainder of the second plurality of data fields having equivalent field types.

17. The system of claim 16, wherein the first plurality of records is a first plurality of patient health records and the second plurality of records is a second plurality of patient health records.

18. The system of claim 17, wherein:
all patient health records of the second plurality of patient health records are synthetic patient health records, and
the first plurality of patient health records does not include synthetic patient health records.

19. The system of claim 18, wherein the instructions, when executed, further cause the processor to, after linking each data field of the at least a portion of the remainder of the first plurality of data fields to the corresponding data field of the at least a portion of the remainder of the second plurality of data fields, train a computer-implemented machine-learning model using data of at least one data field of the first plurality of data fields and at least one linked data field of the second plurality of data fields.

20. The system of claim 19, wherein the computer-implemented machine-learning model is a neural network model.
